(19) United States
(12) Patent Application Publication
(10) Pub. No.: US 2026/0225015 A1
(43) Pub. Date: Aug. 6, 2026

(54) FLOAT SEAL ASSEMBLY

(71) Applicant: Specialty Machine Works, Inc., Gulfport, MS (US)

(72) Inventors: Harry Richard BISHOP, JR., Ocean Springs, MS (US); Daniel Forrest MORGAN, Ocean Springs, MS (US)

(21) Appl. No.: 19/045,285

(22) Filed: Feb. 4, 2025

(51) Int. Cl. B01D 45/18; B01D 45/02

(52) U.S. Cl. CPC B01D 45/18; B01D 45/02

(57) ABSTRACT

Embodiments of the present disclosure generally relate to a float seal assembly. In one or more embodiments, a float seal assembly includes a mounting base defining a draining orifice. Two or more guide rods are coupled to the mounting base. A float seal body is coupled to the two or more guide rods and moves along the guide rods via two or more mounting tabs coupled to the float seal body. One or more travel nuts are coupled to each guide rod to limit the movement of the float seal body along the guide rods.

### BACKGROUND

### Field

Embodiments of the present disclosure generally relate to equipment utilized to separate molten sulfur from various gases, including hydrogen sulfide gas, that are produced during various industrial operations, including oil and gas refining. More specifically, embodiments of the present disclosure relate to a float seal assembly that allows molten sulfur to be separated from sulfur-bearing gases.

### Description of the Related Art

Various industrial processes utilize gaseous compounds containing sulfur, including hydrogen sulfide, mercaptans, carbonyl sulfide, and carbon disulfide. For example, hydrogen sulfide is naturally present in many oil and gas formations. Accordingly, many gas streams contain hydrogen sulfide in numerous stages of oil and gas production, including drilling, transportation, and refining. Hydrogen sulfide is highly corrosive, toxic, and may cause environmental concerns if burned or released into the atmosphere. Thus, conventional methods of processing natural gas involve separating the hydrogen sulfide from the natural gas stream. The resulting hydrogen sulfide gas streams are often further processed to form liquid or molten elemental sulfur. Residual tail gases containing hydrogen sulfide and other sulfur bearing compounds may still flow with the elemental sulfur. Accordingly, there is a need to further separate these sulfur-bearing tail gases from the elemental sulfur.

Current equipment in the industry utilizes a float seal. The float seal floats when the stream flowing has a density greater than the average density of the float seal. When the float seal is floating, the elemental sulfur flows through a draining orifice and the sulfur-bearing tail gases may flow through a different orifice or may be vented to another system. The float seal sinks and forms a seal when the stream flowing has a density less than the average density of the float seal. When the float seal sinks, the float seal should seal the draining orifice so that no further fluid may flow through the draining orifice. Sulfur-bearing tail gases may remain in the vessel after the float seal has sealed the draining orifice. These sulfur-bearing tail gases may then be vented to another system to ensure the vessel is empty.

One issue with current industry equipment is that the float seal does not always sink back exactly onto the draining orifice to create a seal. The float seal may sink into a different location of the vessel. After the elemental sulfur flows through the draining orifice, the remaining sulfur-bearing tail gases may also flow through the draining orifice. Thus, if the float seal does not sink into the correct position and create a proper seal, the entire process will need to be repeated to effectively separate the elemental sulfur from the tail gases. Accordingly, there is a need for a float seal that more reliably sinks onto the draining orifice to create a proper seal.

Another issue with the current industry equipment is that the float seal may slam down onto the draining orifice or other pieces of the vessel. The float seal may float to the top of the vessel as the vessel fills with fluid. As the molten sulfur is rapidly draining, the float seal may also sink rapidly and hit objects in the vessel, such as the draining orifice, with great force. The float seal may cause damage to these objects as it hits them. This will require costly repairs to the vessel and downtime of the vessel equipment that is no longer properly functioning. Accordingly, there is a need for a float seal that does not fall with great force and will not slam into objects of the vessel.

### SUMMARY

Embodiments described herein generally relate to a float seal assembly. More specifically, embodiments described herein relate to a float seal assembly to separate a fluid mixture including fluids of various densities.

In one or more embodiments, a float seal assembly includes a mounting base defining a draining orifice. Two or more guide rods are coupled to the mounting base. A float seal body is coupled to the two or more guide rods and movable along the guide rods via two or more mounting tabs. One or more travel nuts are coupled to each guide rod to limit the movement of the float seal body along the guide rods in an upward direction.

In one or more embodiments, a system for separating a fluid mixture is disclosed. The system comprises a vessel, one or more inlet ports coupled to the vessel, a float seal assembly coupled to the vessel, and two or more outlet ports coupled to the vessel. The float seal assembly includes a mounting base defining a draining orifice, two or more guide rods coupled to the mounting base, a float seal body coupled to the two or more guide rods and movable along the guide rods via two or more mounting tabs, and one or more travel nuts coupled to each guide rod to limit the movement of the float seal body along the guide rods in an upward direction. The fluid mixture flows through the inlet port. The fluid or fluids with a density greater than the average density of the float seal body flow through the draining orifice. After all of the fluid or fluids with a density greater than the average density of the float seal body flow through the draining orifice, the float seal body travels down along the guide rods to seal the draining orifice, preventing the fluid or fluids with a density less than the average density of the float seal body to remain in the vessel. The fluid or fluids with a density less than the average density of the float seal body that remain in the vessel are vented or directed through an outlet port to another system or vessel.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a perspective view of a float seal assembly of the present disclosure in the open position.

FIG. 2A is a cross sectional front view of a float seal assembly of the present disclosure in the open position.

FIG. 2B is a cross sectional front view of a float seal assembly of the present disclosure in the closed position.

FIG. 3 is a cross sectional bottom view of a float seal assembly of the present disclosure.

FIG. 4 is a cross sectional side view of the float seal assembly of the present disclosure.

FIG. 5 is a perspective view of a float seal assembly of the present disclosure installed in a vessel.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure relate to a float seal assembly placed in or on a vessel. A vessel may contain, for example, a mixture of molten sulfur and sulfur-bearing gases. Float seal assemblies according to the present disclosure may be used in various oil and gas processes, including transportation and refining oil and natural gas.

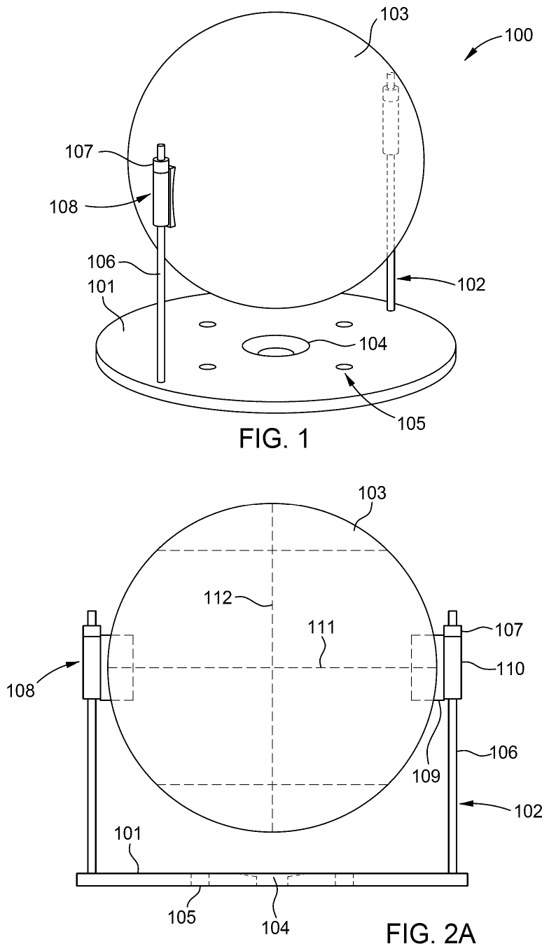

FIG. 1 is a perspective view of a float seal assembly 100. The float seal assembly 100 includes a mounting base 101 defining a draining orifice 104, a guide assembly 102, and a float seal body 103.

The mounting base 101 may be a cylindrical plate with a draining orifice 104 therethrough. The draining orifice 104 may be positioned in the center of the mounting base 101. Additionally, the mounting base 101 may be a rectangular, triangular, or any other shape. The mounting base 101 may have any suitable diameter. In one embodiment, the diameter of the mounting base 101 is twelve inches. The mounting base 101 may include a plurality of mounting holes 105 to couple to a vessel 113. The mounting holes 105 may be of any suitable diameter, including 9/16 of an inch.

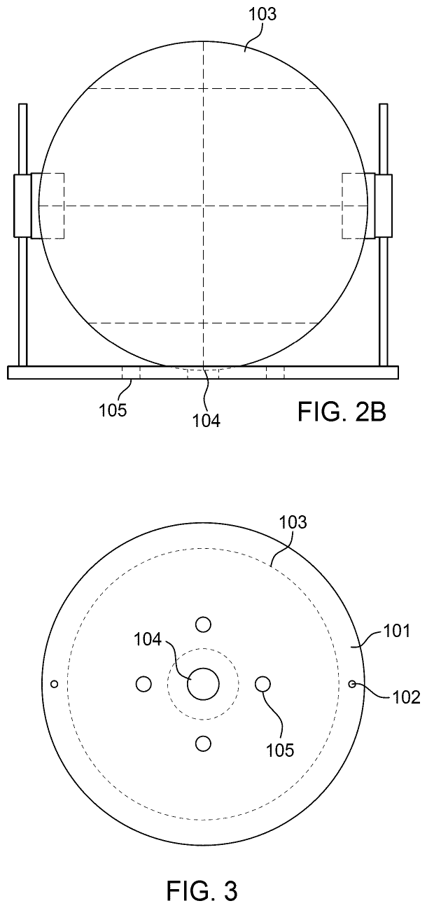

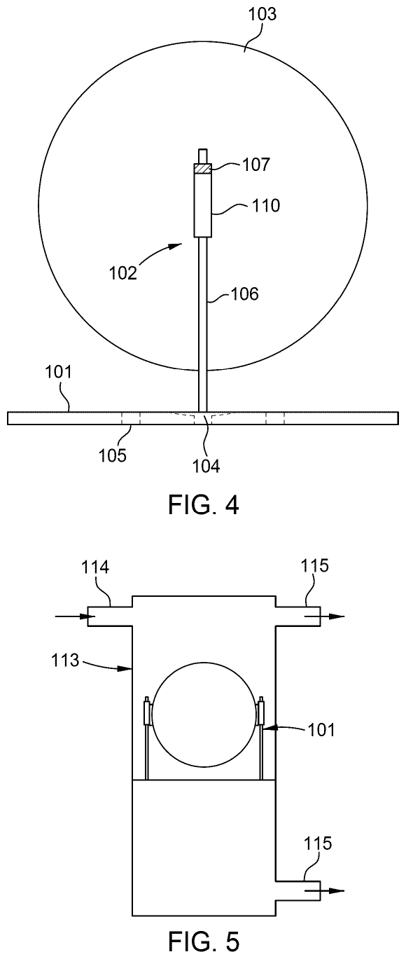

The draining orifice 104 may be a cylindrical hole and may include a beveled edge. The draining orifice 104 may be of any suitable diameter to provide flow access and provide a seal with the float seal body 103. In one embodiment in which the draining orifice 104 is beveled, the diameter of the draining orifice 104 at the top surface of the mounting base 101 is two and one quarter inches and the diameter of the draining orifice 104 at the bottom surface of the mounting base 101 is one and a half inches. In some embodiments in which the draining orifice 104 is beveled to create a recess in the mounting base 101, the volume of the draining orifice 104 in the mounting base 101 is equivalent to or substantially equivalent to a lower portion of the float seal body 103. When the float seal body 103 sits in the draining orifice 104, as depicted in FIG. 2B, a seal is created that prevents fluid from flowing through the draining orifice 104. When the float seal body 103 does not sit in the draining orifice 104, as depicted in FIG. 2A, fluid may flow through the draining orifice 104.

The guide assembly 102 is coupled to the mounting base 101 via two or more guide rods 106 of the guide assembly 102. The guide rods 106 may be of any suitable height. In one embodiment, the height of the guide rods 106 is eight inches. The guide rods 106 may be attached to the mounting base 101 by any suitable means including welding or threading. The guide rods 106 are coupled to the mounting base 101 and extend normal to the surface thereof. In one or more embodiments, the guide rods 106 do not extend perfectly normal from the surface of the mounting base 101. In one or more embodiments, the guide rods 106 may form an acute angle with the mounting base 101, wherein the guide rods 106 are directed towards the center of the mounting base 101. In one or more embodiments, the guide rods 106 may form an obtuse angle with the mounting base 101, wherein the guide rods 106 are directed away from the center of the mounting base 101.

The float seal body 103 is coupled to the guide rods 106 of the guide assembly 102 via two or more mounting tabs 108 and is movable along the guide rods 106 via the two or more mounting tabs 108. The float seal assembly 100 includes at least one mounting tab 108 for each guide rod 106 of the guide assembly 102. Each mounting tab 108 includes a mounting insert 109 and a mounting bushing 110 coupled to one another. The mounting insert 109 couples the float seal body 103 to the mounting bushing 110. Each guide rod 106 is inserted into a mounting bushing 110. The mounting bushing 110 includes an opening with a diameter greater than the outer diameter of a guide rod 106 to be inserted into the mounting bushing 110. A travel nut 107 is threaded on or attached to the guide rod 106 to prevent the mounting bushing 110 from uncoupling from the guide rod 106 and to limit the movement of the float seal body 103 along the guide rods 106 in an upward direction. The travel nut 107 may be adjusted along the guide rod 106 to control the movement of the mounting bushing 110. In one or more embodiments, the travel nut 107 is threaded to the top of the mounting bushing 110 when the bottom of the mounting bushing 110 is in contact with the mounting base 101. In these embodiments, the float seal body 103 is locked into a closed position in which the float seal body 103 sits in the draining orifice 104.

In some embodiments, the float seal body 103 may include horizontal internal structural supports 111, vertical internal structural supports 112, or a combination of both. The internal structural supports may be of any suitable thickness and may extend from any position along the internal surface area of the float seal body 103.

The float seal body 103 may be a sphere-shaped object. In some embodiments, the float seal body 103 is a cone-shaped, triangular prism-shaped, rectangular prism-shaped, or any three-dimensional shape that has a bottom portion equivalent to a bevel of the draining orifice 104. For example, a float seal assembly 100 with a triangular prism-shaped float seal body 103 may have a draining orifice with a cross section of a rectangle.

The float seal body 103 must have an average density less than the density of one or more of the fluids that is to flow through the draining orifice 104 (“more dense fluids”). The float seal body 103 must also have an average density greater than the density of one or more of the fluids that is to be vented to another system or flow through a different orifice other than the draining orifice 104 (“less dense fluids”).

The edge of the float seal body 103 may have any suitable thickness that will result in a suitable average density of the float seal body 103. The float seal body 103 may have any suitable diameter to seal the opening for which it seals. In one embodiment, the diameter of the float seal body 103 is eleven inches.

The float seal body 103 rises along the guide rods 106 when the more dense fluids of the fluid mixture flows through the float seal assembly 100. As the float seal body 103 rises, the guide rod bushings 110 rise along the guide rods 106. The travel of the guide rod bushings 110 is limited by the position of the travel nuts 107. The float seal body 103 will stop rising when the guide rod bushings 110 stop rising because the guide rod bushings 110 are attached to the float seal body 103. The heights of the travel nuts 107 may be adjusted to alter the maximum height the float seal body 103 rises. When all of or substantially all of the more dense fluids have flowed through the draining orifice 104, the float seal body 103 will sink back down to the draining orifice 104 of the mounting base 101 to seal the float seal assembly 100. In the closed position, the less dense fluid does not flow through the draining orifice 104. In one embodiment, the less dense fluid is vented to another system after all of or substantially all of the more dense fluids have flowed through the draining orifice 104. In another embodiment, the less dense fluid is directed through an outlet port 115 to another system.

FIG. 5 is a perspective view of the float seal assembly 100 installed in a vessel 113. The float seal assembly 100 may be coupled to the exterior or interior of the vessel 113. The vessel 113, may include one or more inlet ports 114 and two or more outlet ports 115, 116. A fluid mixture enters the vessel 113 via the one or more inlet ports 114. A fluid mixture flows through the vessel 113 and is selectively separated via the float seal assembly 100. The fluid mixture includes two or more fluids. The fluids include liquids, gases, or any combination thereof. In one embodiment, the fluid mixture includes sulfur containing compounds. In one embodiment, molten sulfur and hydrogen sulfide gas flow through the vessel 113. The more dense fluid or fluids of the fluid mixture flow through the draining orifice and through one of the outlet ports 116 coupled to the vessel 113. The less dense fluid or fluids of the fluid mixture remain after the float seal body 103 has sealed the draining orifice 104. The less dense fluid or fluids of the fluid mixture are then vented or directed through another outlet port 115 coupled to the vessel 113.

Each component of the float seal assembly 100 may be made of a material resistant to corrosion caused by the fluid flowing through the vessel 113. In one embodiment, each component of the float seal assembly 100 is made of stainless steel.

What is claimed is:

1. A float seal assembly, comprising:
a mounting base defining a draining orifice;
two or more guide rods coupled to the mounting base;
a float seal body coupled to the two or more guide rods and movable along the guide rods via two or more mounting tabs; and
one or more travel nuts coupled to each guide rod.

2. The float seal assembly of claim 1, wherein the float seal body has an average density less than the density of at least one fluid of a fluid mixture flowing through the float seal assembly and the float seal body has an average density greater than the density of at least one fluid of the fluid mixture flowing through the float seal assembly.

3. The float seal assembly of claim 2, wherein the float seal body is a sphere-shaped object.

4. The float seal assembly of claim 3, wherein the mounting base has a plurality of mounting holes.

5. The float seal assembly of claim 4, wherein the float seal assembly is mounted to a vessel.

6. The float seal assembly of claim 5, wherein the guide rods are welded or threaded to the mounting base.

7. The float seal assembly of claim 6, wherein a volume of the draining orifice in the mounting base is equivalent to a lower portion of the float seal body.

8. The float seal assembly of claim 7, wherein the float seal body comprises horizontal structural supports, vertical structural supports, or a combination thereof.

9. The float seal assembly of claim 1, wherein the float seal assembly is made of stainless steel.

10. A method of separating two or more fluids of a fluid mixture, the method comprising:
flowing the fluid mixture from an inlet port to a vessel including a float seal assembly, the float seal assembly comprising:
a float seal body coupled to two or more guide rods and movable along the two or more guide rods;
a mounting base defining a draining orifice coupled to the two or more guide rods, wherein the fluid or fluids of the fluid mixture with a density greater than the average density of the float seal body flow through an opening of the draining orifice; and
one or more travel nuts coupled to each guide rod to limit the float seal body's vertical movement along the two or more guide rods as the float seal body rises above the fluid or fluids with a density greater than the average density of the float seal body; and
venting the fluid or fluids of the fluid mixture with a density less than the average density of the float seal body to another system.

11. The method of claim 10, wherein the float seal assembly is made of stainless steel.

12. The method of claim 11, wherein the fluid mixture comprises compounds containing sulfur.

13. The method of claim 12, wherein the mounting base has a plurality of mounting holes to attach the float seal assembly to the vessel.

14. The method of claim 13, wherein the float seal body is a sphere-shaped object.

15. The method of claim 14, wherein the volume of the draining orifice in the mounting base is equivalent to a lower portion of the float seal body.

16. A system for separating a fluid mixture, comprising:
a vessel;
an inlet port coupled to the vessel; and
a float seal assembly coupled to the vessel, the float seal assembly comprising:
a mounting base defining a draining orifice;
two or more guide rods coupled to the mounting base;
a float seal body coupled to the two or more guide rods and movable along the guide rods via two or more mounting tabs; and
one or more travel nuts coupled to each guide rod; and
two or more outlet ports coupled to the vessel.

17. The system of claim 16, wherein the float seal body has an average density less than the density of one of the fluids of the fluid mixture flowing through the float seal assembly and the float seal body has an average density greater than the density of one of the fluids of a fluid mixture flowing through the float seal assembly.

18. The system of claim 17, wherein the fluid mixture enters the vessel via the inlet port and wherein the fluid or fluids of the fluid mixture with a density greater than the average density of the float seal body flow through the draining orifice and out one port of the two or more outlet ports, and wherein the fluid or fluids of the fluid mixture with a density less than the average density of the float seal body flow through a different port of the two or more outlet ports.

19. The system of claim 16, wherein the float seal assembly is coupled to the interior of the vessel.

20. The system of claim 16, wherein the float seal assembly is coupled to the exterior of the vessel.
